(19) United States
(12) Patent Application Publication
(10) Pub. No.: US 2012/0032094 A1
(43) Pub. Date: Feb. 9, 2012

(54) PROCESSING A FLUORESCENCE IMAGE BY FACTORIZING INTO NON-NEGATIVE MATRICES

(75) Inventors: Anne-Sophie Montcuquet, Grenoble (FR); Lionel Herve, Corenc (FR); Jerome Mars, Grenoble (FR)

(73) Assignee: COMMISSARIAT A L'ENERGIE ATOMIQUE ET AUX ENE ALT, Paris (FR)

(21) Appl. No.: 13/255,411

(22) PCT Filed: Mar. 10, 2010
(86) PCT No.: PCT/EP2010/053008

§ 371 Date: Oct. 21, 2011

(30) Foreign Application Priority Data
Mar. 11, 2009 (FR) 09 51505

(51) Int. Cl. G01N 21/64

(52) U.S. Cl. 250/459.1; 250/458.1

(57) ABSTRACT

A method for locating at least one fluorescent tag in a scattering medium, wherein: a) at least one tag is introduced into the medium, b) a fluorescence image is performed by an infrared excitation of the medium along a first axis, the image including a fluorescence component due to the tag, and an auto-fluorescence component due to a medium part other than the tags, c) the image is processed by factorizing into two non-negative matrices, and d) an image of the distribution of the tag(s) is determined, without the auto-fluorescence component.

### TECHNICAL FIELD AND PRIOR ART

This invention relates to the field of optical imaging applied to the medical field. This technique offers the perspective of non-invasive diagnostic systems thanks to the use of non-ionizing radiations, easy to use and cheap. Fluorescent tags are injected to the subject and bind to some specific molecules, for example cancer tumours. The area of interest is lit at the optimum excitation wavelength of the fluorophore (chemical substance of a molecule capable of emitting fluorescence light after excitation) and the fluorescent signal is detected. The optical scattering imaging—without injecting fluorescent tags—is already used in clinical environment, in particular in the fields of mammography and neurology. As for the optical fluorescence imaging (with specific fluorophore injection), it is nowadays focused on “small animal” applications because of the lack of human-adapted and injectable tags, and of the tissue auto-fluorescence problem raised for deep detection. Indeed, to apply this method to human cancer diagnostics, it is essential that the specific signal lying more deeply under the skin than in the small animal can be detected. But the specific signal to be detected weakens with depth, mainly because of absorption and scattering of tissues, and faces a stray signal which disturbs the detection. This signal, called “auto-fluorescence” describes the fluorescence of tissues to which no specific chemical substance or fluorophore has been injected: this is the natural fluorescence of the tissue.

Various works on tissue auto-fluorescence seem to reveal that the possible cause is the presence of protoporphyrin I in living cells. This molecule, which is involved in oxygen transport and in particular goes into the haemoglobin composition, has indeed the property to fluoresce in wavelengths used in optical medical imaging (between about 650 nm and 850 nm). Auto-fluorescence is thus a known phenomenon, but it is now rarely perceived as a stray signal. In particular in cancerology, auto-fluorescence is used to distinguish cancer tissues from healthy tissues. The purpose is then not to inject a specific tag, but merely to observe auto-fluorescence of specific areas and compare different areas of a same individual. The excitation wavelength is then near 400 nm, a wavelength for which the intensity of the auto-fluorescence is maximum. By contrast, the fluorescence optical spectroscopy uses near infrared excitation wavelengths, which ensure a lesser absorption, and allow for a better tissue penetration. The tissue auto-fluorescence is then much lower and becomes a signal to be removed rather than to be used.

Generally, the problem to be solved is thus to find a new method, allowing to differentiate, in an image, the auto-fluorescence contribution from that of fluorescence sources associated to tags.

The problem to be solved is also to find a new device, allowing the implementation of such a method.

### DESCRIPTION OF THE INVENTION

The invention first relates to a method for locating at least one fluorescent tag in a scattering medium, wherein:

a) at least one image or one fluorescence acquisition or a series or a plurality of images of fluorescence acquisitions is performed, by exciting the medium, wherein each image or acquisition can include on the one hand a fluorescence component due to the tag or tags, on the other hand an auto-fluorescence component due to a medium part other than tags, measured data of the image or acquisition or images or acquisitions that can be stored in a multidimensional array X,

b) these data or this array is processed, by factorizing this array into a product of only two non-negative multidimensional arrays, for example two non-negative matrices (if the spatial dimension is equal to 1), A and S,

c) a graphical representation is worked out, of the intensity distribution of one or several fluorescence sources, possibly of the auto-fluorescence which may be considered as a fluorescence source, from the data contained in the array A and S.

The invention also relates to a method for processing an image or acquisition or a series of images or acquisitions of fluorescence in a scattering medium including at least one fluorescent tag, each image or acquisition being obtained by exciting this medium, wherein this image or acquisition can include, on the one hand, at least one fluorescent component due the tag and, on the other hand, an auto-fluorescence component due to a medium part other than the tags, in which method, during a processing step, this data or an array X of data from the series of images or acquisitions are processed by factorizing this array X into a product of only two non-negative multidimensional arrays, for example two non-negative matrices, A and S.

It is then possible to determine a graphical representation or an image of the intensity distribution of a fluorescence source or intensities of different fluorescence sources, each source being a fluorescent tag or auto-fluorescence.

A method according to the invention can follow the introduction of at least one tag into the medium.

In either above-mentioned method, the non-negative first array A of the product AS is an array wherein the elements a_{q,p} of which are weighting coefficients, a_{q,p} being the contribution of the spectrum represented by the p^{th} row of S, at the point of coordinate q. The second non-negative array S is a matrix the rows of which correspond to emission spectra of the fluorescent sources considered, the number of rows of the array S and the number of columns of the array A then corresponding to the number of fluorescence sources considered.

Array X is formed by performing consecutive acquisitions, wherein one acquisition can for example correspond to a given position of the source and a given position of the detector. Each of these positions can be changed by a new acquisition.

Array S is generally a matrix, that is an array of dimension 2, even if each of A and X were to be of dimension strictly higher than 2.

During the processing step of the array X of data resulting from acquisition or the series of acquisitions (this is in particular step b) of the locating method or a step of the processing method), A and S are determined by minimizing a cost or objective function, this function can be or include the Euclidian distance ∥X-AS∥² between the image X and the product A.S.

Besides, during the processing step, at least one row of the array S can be initialized, by a reference spectrum of the corresponding fluorescence source. This reference spectrum can be obtained empirically or from tabulated values.

The obtained array X is preferably processed according to an iterative process.

For example, k iterations are performed, the arrays Aₗ₊₁ and Sₗ₊₁, obtained at the l+1-order iteration being determined from the arrays Aₗ and Sₗ obtained at the l-order iteration. The number of iterations can be determined depending on fluctuations in the arrays A and S, or automatically, depending on fluctuations in the cost function during 2 or more consecutive iterations. This number of iterations can also be empirically determined, depending on the user's experience.

In the processing step, A and S can be determined by an iterative process including, at each iteration, minimizing a cost function, this cost function including:
a distance between the array X and the product of the arrays A and S,
at least one distance between an array (A, S) and an initial array (A⁰, S⁰).

At the step of determining the graphical representation of intensity distribution of different fluorescence sources (due to the tag(s) or auto-fluorescence), the position of one of the sources can be obtained by removing the contributions of the other sources in the array S, and then by making the product of A with the array S thus changed. It is also possible to replace the coefficients of columns of the array A that do not correspond to the chosen source by a zero value. It is also possible to extract the column from A and the row from S corresponding to the source being searched for and to make the product with this column and this row.

The medium excitation can be performed by a laser excitation source, which may possibly be focused at the interface between the scattering medium and the external medium. The excitation light will then penetrate the scattering medium, and excite tags or sources in this medium, for example at 3 cm or 5 cm deep, that is away from the interface, in the scattering medium. The fluorescence radiation thus comes from a deep area, for example between the interface and about 3 cm or 5 cm away from the interface, or between 1 cm away from the interface and 5 cm away from the interface.

The excitation can occur in infrared or near infrared, for example at a wavelength between about 600 and 900 nm. As for the fluorescence, it can be detected at wavelengths higher than 700 nm or 750 nm. An excitation at a wavelength higher than 750 nm or 800 nm is also possible with, for example, a fluorescence at a wavelength higher than 800 nm or 900 nm.

The acquisition can be performed by an image sensor producing an image which gives, for points of the studied area, the spectral distribution of fluorescence radiation coming from these points.

Each acquisition can be performed using a detector including a row of unit detectors; the row of detectors can be moved, a fluorescence acquisition being performed for each position of the row of detectors.

The excitation can be performed using a laser, and the excitation row is moved, wherein a fluorescence image (X) can be performed for each position of the excitation row.

The invention also relates to a device for locating at least one fluorescence tag in a scattering medium, including:

a) means for producing an excitation beam and means for focusing this beam,

b) means for performing an acquisition or image or series of acquisitions or images of fluorescence of points or sources of the medium, wherein each acquisition can include the fluorescence components due to different fluorescence sources present, for example on the one hand one or several tags and on the other hand auto-fluorescence,

c) means for processing an array X of the data obtained by the series of acquisitions by factorizing into two non-negative arrays A and S,

d) means for determining a graphic representation of the intensity distribution of different fluorescence sources, wherein these different sources can be one or more fluorescent tags and auto-fluorescence.

The means for forming an acquisition or an image or a series of acquisitions or images preferably include an image sensor giving, for points of the studied area, the spectral distribution of fluorescence radiations coming from these points. The focusing preferably occurs at the interface of the medium with the surrounding medium.

The means for producing a laser beam enable the production of an area, called excitation area, focused for example at the interface of this medium with the surrounding medium. The excitation light then penetrates the medium, scatters therein, and will excite the fluorescence sources, tags and auto-fluorescence. This excitation area can be an excitation row. As explained above, the fluorescence sources can be located in depth, away under the interface.

A device according to the invention can further include means for changing the position of this excitation area, a fluorescence image being made for each position of the excitation area.

At least one part of the means for performing a detection of the fluorescence signal from said medium can be disposed along a row, called detector row. A device according to the invention can further include means for changing the position of this row along two axes.

The means for processing the acquisition matrix (or multidimensional array) by factorizing into two non-negative arrays A and S implements a method according to the invention, as already described above.

### BRIEF DESCRIPTION OF THE DRAWINGS

FIG. 1 represents a device for implementing the invention,

FIG. 2 illustrates how a fluorescence acquisition is made,

FIG. 3 represents a fluorescence acquisition obtained, with auto-fluorescence and fluorescence,

FIGS. 4A and 4B respectively schematically represent a matrix S of spectra, with 2 fluorescent sources and thus 2 rows, and a product of two arrays, including the matrix S, for obtaining the array X,

FIGS. 5A and 5B respectively represent an auto-fluorescence and fluorescence spectral model, for initializing a matrix S in a method according to the invention,

FIG. 6 represents auto-fluorescence and fluorescence spectra detected after processing according to the invention, and a comparison with initial models,

FIGS. 7A and 7B respectively represent an auto-fluorescence image, and a fluorescence image, obtained after processing according to the invention of the image of FIG. 3,

FIG. 8 represents steps of a method according to the invention,

FIGS. 9, 10A and 10B represent fluorescence images (FIGS. 9 and 10B), and an auto-fluorescence image (FIG. 10A), obtained after processing, according to methods of prior art, of the image of FIG. 3.

### DETAILED DESCRIPTION OF EMBODIMENTS OF THE INVENTION

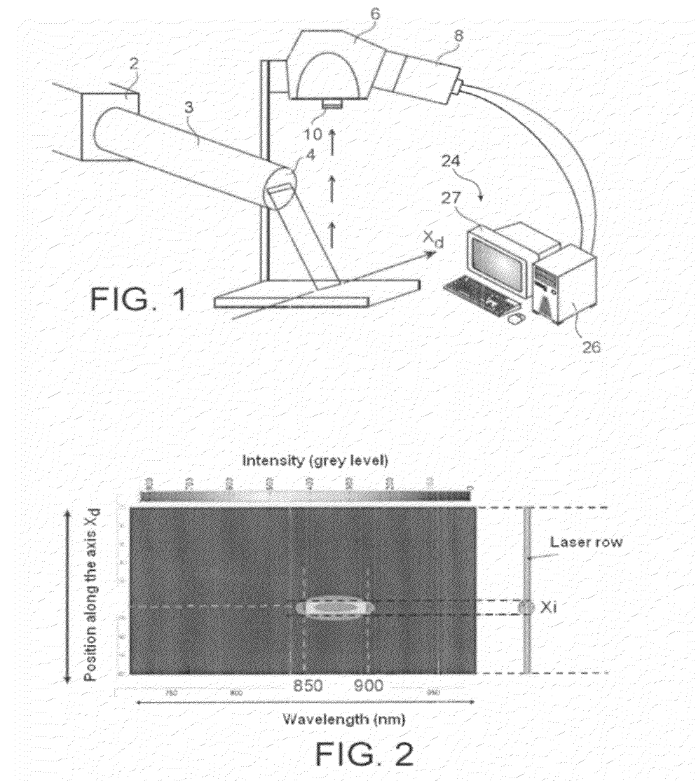

FIG. 1 is an exemplary system enabling the implementation of the invention.

The illumination of an area of an object (not represented in the figure) is achieved using a continuous laser 2 the beam of which, which emits for example in infrared or even a near infrared radiation, is focused with focusing means to reach some area on the surface of the scattering medium, wherein this area can be a row. The excitation light then scatters in an area of the scattering medium, different from the preceding area and will excite one or more fluorescent species therein.

Means 6 are for performing a spectral splitting of the fluorescence radiation emitted by the scattering medium studied in the external medium. These means 6 are coupled to image sensor means 8, for producing an image which gives, for points of the studied area, the spectral distribution of the fluorescence radiation coming from these points. The image sensor of this means 8 is a linear matrix (N_{λ},N_{xd}), where N_{λ} is the number of channels corresponding to the range of wavelengths considered, and N_{xd} is the number of pixels corresponding to the number of points detected on the row.

Means 8 include means for digitizing the image. Means 24 for processing these data will allow the implementation of a processing method for analysing the digital data thus obtained, in particular in terms of spectral and/or spatial distribution of fluorescent tags. This electronic means 24 include for example a microcomputer programmed for storing and processing data acquired by the means 8. More precisely, a processing central unit 26 is programmed to implement a processing method according to the invention. Displaying or viewing means 27 allow, after processing to represent the positioning or spatial distribution of fluorophores in the examined medium. The means 24 possibly allow the control or monitoring of other parts of the experimental device.

The studied medium is a scattering medium, for example a biological tissue. In this kind of medium, an incident radiation can penetrate the medium, wherein the penetration depth into the medium can reach a few cm depending on the extinction coefficient of this medium, for example 3 cm or 5 cm. In other words, it will be possible to detect fluorophores lying at a distance between 0 cm (thus lying very close to the surface) and 3 cm or 5 cm.

The detection means 6, 8, thus detect a radiation from the area of the scattering medium excited by the laser beam, which passes through the scattering medium to the boundary between the scattering medium and the external medium, and then reaches the detection and spectral splitting means 6. The detection means are not necessarily focused on the excitation area or row, but can be offset and target another area or row, in particular on the surface of the medium. This embodiment is made possible due to light scattering in the medium.

Typically, the studied medium can be a living medium. It can be for example an area of a human or animal body. A body layer is the interface of the scattering medium with the external medium. An excitation source is thus focused on this interface, for example along a row. Tags injected into this scattering medium allow to locate areas such as tumours.

As will be seen, there is also an excitation of other elements of this medium, creating a stray fluorescence, or auto-fluorescence. An image can be viewed on viewing means 27.

In the illustrated example, a laser source with an excitation wavelength equal to 690 nm is focused along a row on the interface and allow an excitation of fluorophores to be performed in the scattering medium, at a depth that can reach a few centimeters. The row can be fixed, and in this case, only a single row of the object is acquired. But translation platens can be used as well in order to acquire row by row the fluorescence image of a portion of an object or of an entire object. These platens can be controlled by means such as means 24, 26, 27 of FIG. 1. By making several images this way, a signal can be obtained from all or part of an area located in the object. Each image can be processed as set out in the present description.

The source 2 can be coupled to a laser fibre 3. A lens 4 allows the beam to be focused as a laser row at the interface of the studied medium.

The laser excitation can be positioned above the object, as in FIG. 1, and a reflection observation can then be made: the fluorescence signal is detected above the object, or even on the same side of the object than that the radiation source, by an imaging spectrometer 6 coupled to a CCD camera 8. An excitation filter is used, enabling the laser signal to be refined. A system 10 allows a high-pass filtering, which cut off the wavelengths below 700 nm, this being for example a system of filters RG9. This filtering is positioned in front of the objective, to block the stray excitation from the laser beam itself. The acquired image is then obtained using a software from the supplier Andor or Labview, and the system and the translation platens can be driven by a single Labview interface.

FIG. 1 also highlights an axis X_{d} which describes the position of the Nx_{d} detectors aligned along a detection row in the means 8.

This axis X_{d} is shown again in FIG. 2, which gives a schematic example of the kind of image that can be acquired with a system such as described above and of the information that can be found therein.

The fluorescence along the detection row is detected, and a wavelength spectrum (in abscissa) of points of the row (that is the points i_{xd} of the ordinate axis X_{d} of FIG. 2) is performed.

(i_{xd}, i_{yd}) stand for the coordinates of the point detector.

(iₓₛ, i_{ys}) designate the coordinates of the point source, for example a laser source. In the case of a laser source in a row, this source can be considered as containing Nₓₛ (≧2) unit sources along the row.

A single fluorescent source is herein detected along the row at the position i_{xd} at the source positioning point, in the wavelength range between 850 and 900 nm.

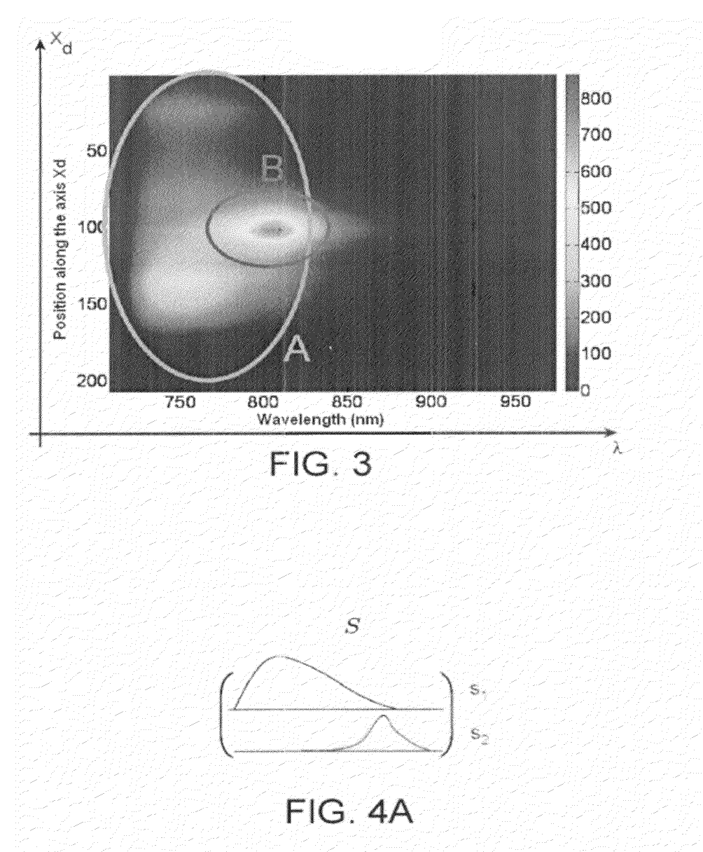

A real image is much more complex, and mixes contributions, both of auto-fluorescence and one or more fluorescence sources, this fluorescence coming from fluorophores present in the scattering medium examined. One exemplary acquisition performed for a near infrared excitation is illustrated in FIG. 3. Experimentally, it corresponds to the case of a capillary (glass tube filled with indocyanine green (ICG)) lying, in subcutaneous position, at the back of a mouse. The source excites the fluorophore present in the capillary as well as the surrounding biological tissues, which generates auto-fluorescence.

Two main parts are seen in this image: a first part A which is auto-fluorescence visible throughout the acquisition row Xd the maximum intensity of which is about 700 nm. The second part B is the fluorescence due to the fluorophore (ICG—indocyanine green), it is spatially more localized than auto-fluorescence and its emission spectrum has a peak around 860 nm.

On such an image, by source is meant a set of points having a same emission spectrum. A fluorescent source can thus include several emission areas, distributed at various positions in the scattering medium.

Such an image can be processed by a method according to the invention, in particular in order to separate the auto-fluorescence contribution in one hand and that of the fluorescence source(s) on the other hand, the latter coming from fluorophores present in the examined medium.

But, in view of the processing, the auto-fluorescence is considered as a fluorescent source in the same way as a fluorophore.

A data processing technique is described by Lee and Seung in the paper “Algorithms for Non Negative Matrix Factorisation”, published in Advances in neural information processing systems, pages 556-562, 2001.

According to this technique, given a non-negative matrix X, of the size N_{xd}*N_{λ} (that is N_{xd} rows and N_{λ} columns), the non-negative matrices A and S are searched for, respectively of the sizes N_{xd}*P and P*N_{λ}, that meet the condition:

X≈AS (1)

By non-negative matrix, it is meant a matrix all the elements of which are non-negative. P corresponds to the number of fluorescence sources considered.

The matrix X corresponds to the digitalized image which has been obtained by the measurement: X is the matrix expression of the image. The matrix A is called weighting matrix and an element a_{ixd,p} (≧0) of this matrix represents the weight of the source p at the position i_{xd} of the measurement row X_{d}. It is of the size N_{xd}*P, the number of rows N_{xd} representing the number of points selected along the fluorescence row, the number of column p representing the number of sources likely to be present in the medium: fluorescent tags and possibly auto-fluorescence.

S is called spectrum matrix and s_{p,iλ} (≧0) represents the iλth value of the spectrum of the p^{th} source. It is of the size P*N_{λ}, the number of rows P representing the number of fluorescence sources (including auto-fluorescence), the number of columns N_{λ} representing the number of data of the spectrum of each source. In other words, each row of the matrix S corresponds to the emission spectrum of a fluorescent source, this spectrum being discretized along N_{λ} channels.

In theory, each source, except for the auto-fluorescence, has a spectrum similar to that of a monochromatic source; but in practice, there is some splitting about a centre frequency. The row p of the matrix S can thus include several non-zero elements.

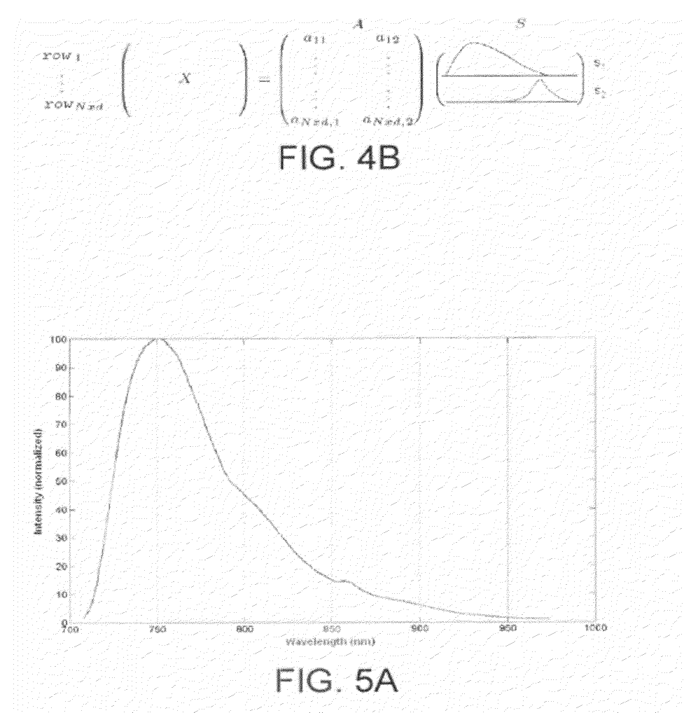

FIG. 4A gives the imaged example of a matrix S for an acquisition with two fluorescence sources considered: the two rows represent the emission spectra of the two sources considered. The first one, has a wider spectral distribution than the second. At the first row of the matrix S, it is rather the first elements of the sequence s_{1iλ} (i_{λ}=1, . . . N_{λ}) that are non-zero, whereas at the second row, it is rather the last elements of the sequence S_{2iλ} (i_{λ}=1, . . . N_{λ})) that are non-zero.

In the case of two sources (P=2) and N_{xd} points along the row, which corresponds to Nxd detectors, we have thus:

$$X = ( \begin{matrix}{x}_{11} & … & {x}_{1 , N λ} \\ ⋮ & ⋱ & ⋮ \\ {x}_{Nxd , 1} & … & {x}_{Nxd , N λ}\end{matrix} ) = ( \begin{matrix}{a}_{11} & {a}_{12} \\ ⋮ & ⋮ \\ {a}_{Nxd , 1} & {a}_{Nxd , 2}\end{matrix} ) ( \begin{matrix}{s}_{11} & & {s}_{1 , N λ} \\ {s}_{21} & & {s}_{2 , N λ}\end{matrix} )$$

FIG. 4B gives the imaged example of the product of a matrix S (for an acquisition with two fluorescent sources) with an array in order to obtain the array X.

S contains information about the fluorescence spectra, whereas A defines their weighting of in each row of X.

The solution to above equation (1) is obtained in a approximate manner, through iterations.

In practice, there is an attempt to minimize an objective function. In this example, the Euclidian distance between the matrix X and the product of both matrices A and S is considered. In other words, there is an attempt to minimize the amount:

∥X−AS∥²

With A≧0 and S≧0.

In other words, a cost or objective function is defined, Q^{FMN}, which is written:

$${Q}^{FMN} = {\sum }_{ixd = 1}^{Nxd} {\sum }_{i λ = 1}^{N λ} {( {x}_{ixd , i λ} - {\sum }_{p = 1}^{P} {a}_{ixd , p} {s}_{p , i λ} )}^{2}$$

where x_{ixd,iλ} is the element in row i_{xd} and in column i_{λ} of the matrix X, and a_{ixd,p} is the element in row i_{xd} and in column p of the matrix A, and s_{p, iλ} is the element in row p and in column i_{λ} of the matrix S.

This function has the value 0 for lower bound and becomes zero if and only if X=A S.

The algorithm starts with an initialization of the matrices A and S to the desired dimensions, and by fulfilling the positivity constraints. The columns of A are randomly initialized, whereas the rows of S are initialized by reference spectra, representing the estimated emission spectra of fluorescent sources searched for or corresponding to these spectra. These spectra are determined empirically or according to tabulated values. The matrices are initialized, but then change during the algorithm. The minimization of the function Q^{FMN} is made in two iterative steps. First, for S set, the matrix A is searched for. Then, for A set, the matrix S is calculated. The formula for updating matrices A and S are then:

$${a}_{ixd , p} = {a}_{ixd , p} \frac{{\sum }_{i λ = 1}^{N λ} {x}_{ixd , i λ} {s}_{p , i λ}}{{\sum }_{l = 1}^{P} ( {a}_{ixd , l} {\sum }_{i λ = 1}^{N λ} ( {s}_{l , i λ} {s}_{p , i λ} ) )}$$

$${s}_{p , iλ} = {s}_{p , i λ} \frac{{\sum }_{ixd = 1}^{Nxd} {a}_{ixd , p} {x}_{ixd , i λ}}{{\sum }_{l = 1}^{P} ( {s}_{l , i λ} {\sum }_{ixd = 1}^{Nxd} ( {a}_{ixd , p} {a}_{ixd , l} ) )}$$

These laws, one simplified, are equivalent to:

$${a}_{ixd , p} = {a}_{ixd , p } \frac{{( {XS}^{T} )}_{ixd , p}}{{( {ASS}^{T} )}_{ixd , p}}$$

$${s}_{p , i λ} = {s}_{p , i λ} \frac{{( {A}^{T} X )}_{p , i λ}}{{( {A}^{T} AS )}_{p , i λ}}$$

The objective function converges to a local minimum, and the updating laws ensure that the objective function decreases.

The algorithm implemented within the scope of the invention is thus an iterative algorithm which updates the matrices A and S being searched for according to the updating functions described above which minimize the objective function (Euclidian distance between X and A.S) as the iterations proceed.

The number of iterations is determined depending on fluctuations of the matrices A and S, or automatically, depending on fluctuations in the cost function, Q^{FMN}, during 2 or several consecutive iterations, or empirically.

The initialization of the algorithm consists in theory in creating two random matrices A and S, and then updating them during iterations.

In the case of a spectrum such as that of FIG. 3, this method has been tested but only a few cases among tens converge to a physically reasonable result.

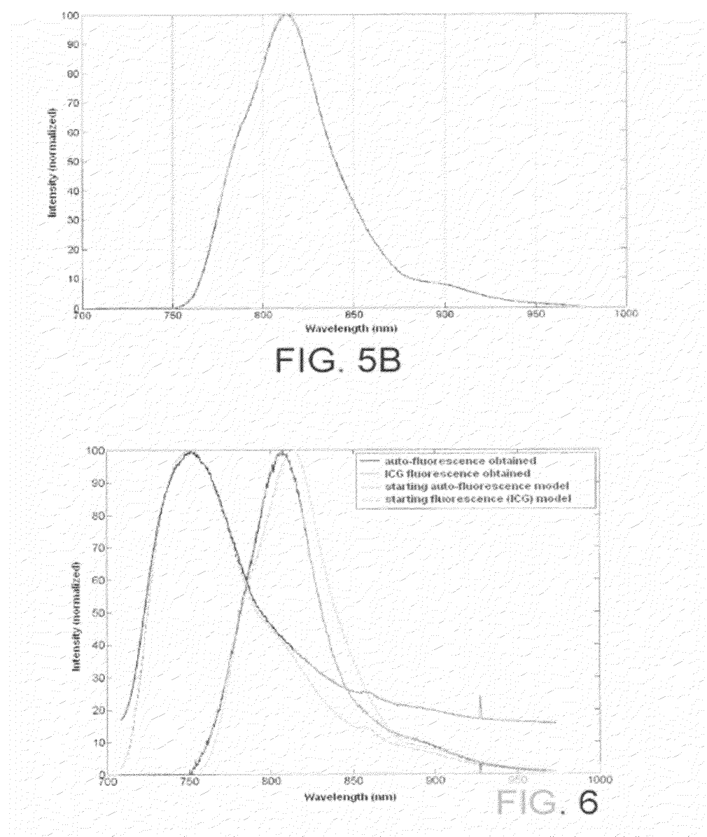

For this reason, according to the invention, at least the first rows, and preferably all the rows (for more robustness) of the matrix S are chosen upon initializing, which amounts to giving the approximate form of spectra of corresponding sources. Therefore, approximate spectra are chosen, one of which for auto-fluorescence, the others being those of the fluorescence source(s) due to the tag(s). For example, in the case of a single fluorescent tag, two models of spectra are chosen, one for auto-fluorescence and another for the tag fluorescence, as respectively illustrated in FIGS. 5A and 5B, based on an a priori knowledge of the tag auto-fluorescence and fluorescence.

The columns of A are randomly initialized, the initialization of rows of S as above described turning out to be sufficient for the initialization step for a satisfactory final result.

Furthermore, positivity constraints are applied: initialization matrices with positive coefficients are chosen, the updating laws then retaining this positivity. Once the initialization matrices A and S have been determined, the algorithm allows the matrices A and S to be updated according to the laws explained above.

Thus, according to the invention:
initialization matrices A and S which fulfil the positivity constraints are chosen,
the objective function is minimized in two iterative steps:
for S set, the matrix A is updated,
for A set, the matrix S is updated.

Once the matrices A and S have been found, it is possible to find the spatial distribution:
of the first fluorescence source by making the product AS′, the matrix S′ being then the matrix S for which the spectrum of the second source is off (thus s_{2,iλ}=0 for any i_{λ});
and/or of the second fluorescent source by making the product AS′, the matrix S′ being then the matrix S for which the spectrum of the first source is off (thus s_{1,iλ}=0 for any i_{λ});
and/or of the p^{th} fluorescent source by making the product of the column p of A by the row p of S;
and/or of the p^{th} fluorescent source by making the product A′S, the matrix A′ being then the matrix A for which all the coefficients of the columns other than the p^{th} column are zeroed.

The intensity distribution of each fluorescence source (tags or auto-fluorescence) can therefore be represented separately from that of other sources.

In practice, this means that it is possible to obtain the spatial distribution of all or part of fluorescence sources made of the tags and auto-fluorescence.

A method according to the invention implements an image processing process which, applied to the image of FIG. 3, leads to the results of FIGS. 5A, 5B, 6, 7A and 7B.

FIGS. 5A and 5B present the appearance of spectra chosen for initializing the two sources, that is the two rows of the initial matrix S.

FIG. 6 presents the final appearance of spectra of two detected main sources in solid line (the initialization spectra are in dotted line), for auto-fluorescence and fluorescence (ICG).

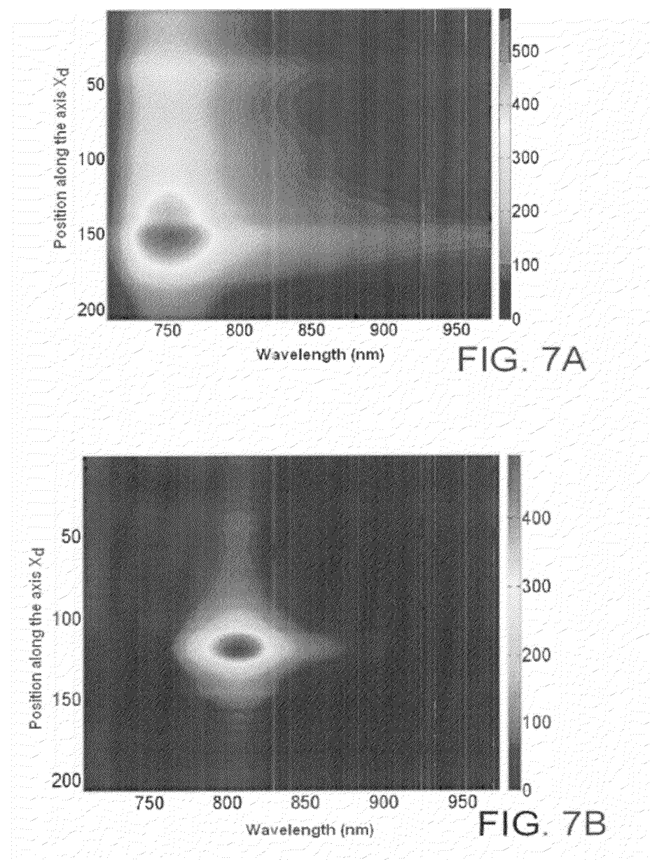

FIGS. 7A and 7B represent the result in images: the fluorescence (FIG. 7B) can be separated from the auto-fluorescence (FIG. 7A).

One of the advantages of this method is the consistency in data, since the aim here is only to process and obtain positive data.

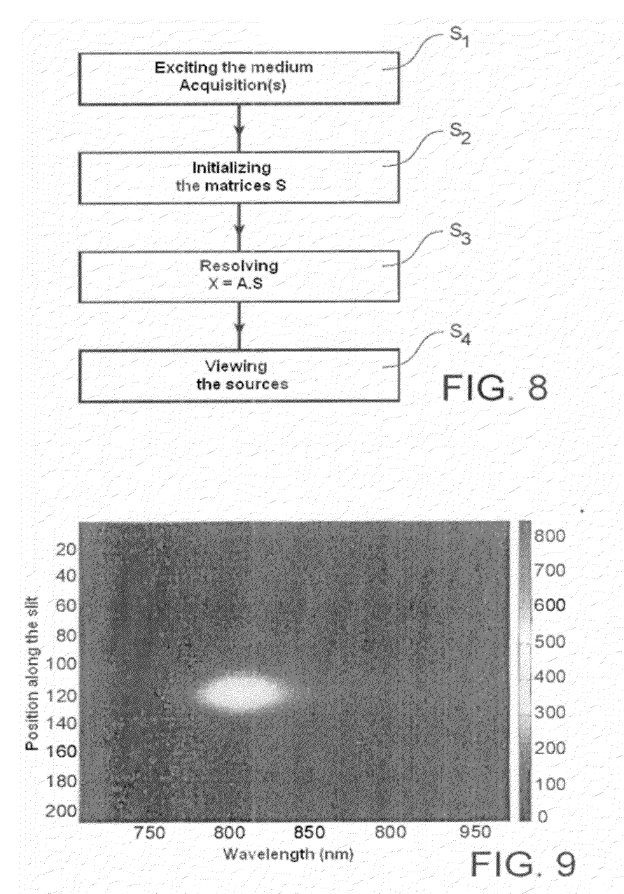

Steps of a method according to the invention are represented in FIG. 8:
in a step S1, one or more acquisitions are performed by exciting the scattering medium by laser beam; this results in for example one or more images,
in a step S2, the matrices A and S are initialized,
the equation X≈A.S can then be resolved, iteratively as explained above (steps S3),
a graphical representation of one or several fluorescence sources, or a viewing of one or several sources (step S4), then can be performed, by selecting the desired source, for example by zeroing, in the matrix S, the coefficients of other sources.

Thus, an image corresponding to photons produced by one or several fluorescent sources is constructed, for example by multiplying respectively the column(s) of the corresponding matrix A by the row(s) of the matrix S corresponding to selected source(s) being searched for.

A comparison with results obtained with other methods has been carried out.

Thus, the same image, the one of FIG. 3, has first been processed by the method by mere subtraction, for example as explained in U.S. Pat. No. 7,321,791 or in WO 2005/040769.

The obtained result is that of FIG. 9: the iterative algorithm used enables the specific fluorescence to be isolated, but “image motions” remain visible in the obtained image, and the specific fluorescence intensity is lower than for results obtained by factorizing non-negative matrices. Further, it is possible to obtain negative values, which is ill-suited to spectral data.

The same image has then been processed by the so-called singularly valuable decomposition explained for example in D. Kalman, “A Singularly Valuable Decomposition: the svd of a Matrix”, the College of Mathematics Journal, 27(1), 2-23, 1996 or by G. W. Stewart, “On the Early History of the Singular Value Decomposition”, SIAM Review, 35(4), 551-566, 1993.

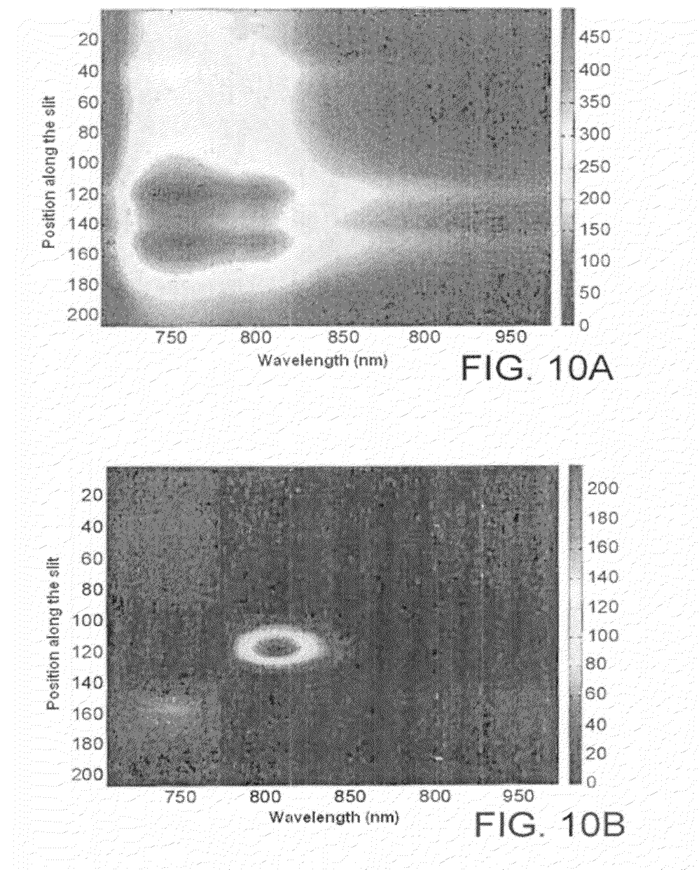

The obtained result is respectively presented in FIG. 10A, for the auto-fluorescence part, and in FIG. 10B, for the specific fluorescence part. It is seen that the latter presents remarkable defects (for example very “resolved” distributions which do not correspond to physical realities). Furthermore, this method does not process only positive values, but can also return negative values, which is ill-suited once more to spectral data being manipulated.

Consequently, processing methods such as the mere subtraction of model of singularly valuable decomposition (SVD) are not suitable for use in separating spectra.

According to the invention, positive signals are processed, and then only positive matrices are found, unlike the SVD technique which can result in matrices having negative values, which does not correspond to the physical reality.

What has been described above implements a reflection measurement geometry, as seen in FIG. 1; in this geometry, the excitatory source is located on the same side as the detector with respect to the scattering product. A transmission geometry can also be implemented wherein the detector is lying in front of another face of the scattering object, for example the object is provided between the excitation source and the detector.

The acquisition and the processing along a row of N_{xd} detectors i_{xd}, have been previously described, the row being not necessarily in line with the laser row. It will be now described how the invention can be implemented:
by moving the row of detectors along an axis Yd, preferably perpendicular to the axis Xd formed by the N_{xd} detectors i_{xd}. Thus, each detector will have coordinates (i_{xd}, i_{yd}) along the axes Xd and Yd respectively, with 1<i_{xd}<N_{xd} and 1<i_{yd}<N_{yd}. In this case, the laser row remains preferably fixed. In the preferred case, each detector is in line with the axis Xd and there is a movement along the axis Yd in order to have a measure for all the (ixd, iyd) coordinates of the detectors,
and/or by moving the laser row along an axis Ys preferably perpendicular to the axis Xs of this row. In this case, the row of detectors remains preferably fixed. The coordinates of unit source are then iₓₛ and i_{ys}. In a preferred case, the source is linear along an axis Xs and it is moved along the axis Ys. In this case, ixs remains constant and only iys changes.

According to a preferred embodiment of the invention, either the source in row, or the detector is moved.

If only the source is moved along the axis Ys, the coordinates (ixs, iyd) are useless. Only the coordinates (ixd, iys,iλ) are useful such that X (and A) can be considered as (only) three dimension arrays.

If only the detector is moved, only the coordinates (ixd, iyd, iλ) are useful. And X (and A) can be considered as 3D arrays.

In the first embodiment described above, neither the source, nor the detector is moved. Only the coordinates (ixd, iλ) are then useful. X (and A) could be considered in this case as 2D arrays.

Now, the source and/or the detector is moved. The device can then be again that of FIG. 1, for example. Movements can be achieved by means for moving the detector 8 of FIG. 1 (for example by translation platens) and/or the position of the laser beam of the same figure (for example once again by translation platens). This movement means are for example controlled by a computerized processing means 24.

The marks Xd, Yd and Xs, Ys can be respectively associated to a reference plane, that can be the working plane on which the object to be analysed is disposed, or the source moving plane, or the detector moving plane.

An image or a data array obtained in each configuration can be processed regardless of the images or arrays obtained in other configurations, a configuration designating an acquisition with the detector and the laser row in a determined position. Then, for each image obtained or each array obtained, a processing as described above can be used.

But the fluorescence acquisition with a movement of the detection row and/or the source position offers new possibilities which will be now described. Therefore, one takes advantage of the fact that each fluorescence source is not purely punctual but presents a certain spatial extension. Thus, rather than processing each acquisition regardless of the other, it seems useful to perform a processing of a series of acquisitions. The processing will then relate to factorizing an array X including all the data measured during this series of acquisitions.

In the case where the laser row is fixed and the Nxd detectors are moved, between two consecutive acquisitions, along an axis Yd, we have:

X≈A*S

where X is an array of dimensions (i_{xd}, i_{yd},i_{λ}), and where i_{xd} and i_{yd} are the coordinates of a unit detector along the axis Xd and Yd.

In the case where the laser row is moved between two consecutive acquisitions and the N_{xd} detectors are fixed:

X≈A*S

where X is an array of dimensions (i_{xS}, i_{yS},iλ), and where i_{xS} and i_{yS} are the coordinates of a unit source along the axes Xs and Ys.

If the laser row and the detectors are simultaneously moved between two consecutives acquisitions, we have:

X≈A*S

X being then an array of dimensions (i_{xd}, i_{yd}, iₓₛ, i_{ys}, iλ).

Each of the three preceding cases can be written as

X≈A*S

X being an array of dimensions (q, iλ), with
q=(i_{xd}, i_{yd}) when the detectors are moved and the laser row is fixed,
q=(iₓₛ, i_{ys}) when the detectors are fixed and the laser row is moved,
q=(i_{xd}, i_{yd}, iₓₛ, i_{ys}) when the detectors and the laser row are moved.

q can then be described as super index.

We will then have:

X_{q,iλ}≈A_{q·p}S_{p,iλ}

A and S are multidimensional arrays all the elements of which are positive. As well as previously described, A and S are initialized and then determined according to an algorithm for factorizing into non-negative matrices. The expression non-negative matrix can be replaced by “array” because A can have a dimension higher than 2.

S is called matrix of spectra and s_{p,iλ} (≧0) represents the i_{λ}^{th} value of the spectrum of the p^{th} source of fluorescence. Its size is P*Nλ, the number of rows P representing the number of fluorescence sources (including auto-fluorescence), the number of columns Nλ representing the number of data of the spectrum of each source. In other words, each row of S corresponds to the emission spectrum of the fluorescence source, this spectrum being discretized along Nλ channels.

The algorithm starts with an initialization of the array A and the matrix S at the desired dimensions, and by fulfilling the positivity constraints. The array A is randomly initialized, whereas the rows of S are initialized by reference spectra, representing the sources being searched for. These spectra are determined empirically or according to tabulated values.

The algorithm arises from a minimization of a cost or objective function Q^{FMN}.

In the case where this function is the Euclidian distance between X and the tensorial product A*S, and in the configuration wherein the laser row is fixed and the detectors are moved along Xd and Yd, the updating laws are written:

$${a}_{ixd , i y d , p} = {a}_{ixd , iyd , p} \frac{{\sum }_{i λ = 1}^{N λ} {x}_{ixd , iyd , i λ} {s}_{p , i λ}}{{\sum }_{l = 1}^{P} ( {a}_{ixd , iyd , l} {\sum }_{i λ = 1}^{N λ} ( {s}_{l , i λ} {s}_{p , i λ} ) )}$$

$${s}_{p , i λ} = {s}_{p , i λ} \frac{{\sum }_{ixd = 1}^{Nxd} {\sum }_{iyd = 1}^{Nyd} {a}_{ixd , iyd , p} {x}_{ixd , iyd , i λ}}{{\sum }_{l = 1}^{P} ( {s}_{l , i λ} {\sum }_{ixd = 1}^{Nxd} {\sum }_{iyd = 1}^{Nyd} ( {a}_{ixd , iyd , p} {a}_{ixd , iyd , l} ) )}$$

Advantageously, further spatial constraints can be considered, such as for example smoothing the coefficients of the matrix A. The function to be minimized then becomes:

Q₂^{FMN}=Q^{FMN}+α₂C₂=Q^{FMN}+α₂(∥∇ₓA_{ixd,iyd,p}∥²+∥∇_{y}A_{ixd,iyd,p}∥²)

Q^{FMN} then representing the objective or cost function previously described, that can be for example the Euclidian distance between X and the tensorial product A*S. α₂ is a positive real number.

In a same way, an algorithm allowing a smoothing of each spectrum of S can be implemented. The function to be minimized is then:

Q₃^{FMN}=Q^{FMN}+α₃C₃=Q^{FMN}+α₃∥∇_{λ}S_{p,iλ}∥²

α₃ is a positive real number.

S can also be imposed a constraint in the distance of each spectrum of the array S and each corresponding initial spectrum, that is each spectrum of the initial array S⁰.

The function to be minimized is then:

Q₄^{FMN}=Q^{FMN}+α₄C₄=Q^{FMN}+α₄∥S_{p,λ}−S_{p,λ}⁰∥²

α₄ is a positive real number.

In other words, the function to be minimized Q₄^{FMN} a distance between X and AS (Q_{FMN}), and a second distance between the array S resulting from the current iteration, and the array S⁰ set upon initializing, or initial array S⁰, wherein this second distance can be weighted by a positive or strictly positive real number α₄.

According to the preceding equation, the updating laws are written:

$${S}^{( i + 1 )} = {S}^{( i )} \frac{{A}^{t ( i )} X + {α}_{4} {S}_{0}}{{A}^{t} {AS}^{( i )} + {α}_{4} {S}^{( i )}} .$$

In a similar way, A can be imposed a constraint in the distance of each column of the array A and each corresponding initial column, that is each column of the initial array A⁰.

The function to be minimized is then:

Q_{4′}^{FMN}=Q^{FMN}+α_{4′}C_{4′}=Q^{FMN}+α_{4′}∥A_{q,p}−A_{q,p}⁰∥²

α₄′ is a positive or strictly positive real number

In other words, the function to be minimized Q_{4′}^{FMN} combines a distance between X and AS (Q^{FMN}), and a second distance between the array A resulting from the current iteration, and the array A⁰ set upon initializing, or initial array A⁰, wherein this second distance can be weighted by a positive or strictly positive real number α_{4′}.

According to the preceding equation, the updating laws are written:

$${A}^{( i + 1 )} = {A}^{( i )} \frac{{XS}^{t ( i )} + {α}_{{4}^{′}} {A}_{0}}{{A}^{( i )} {SS}^{t} + {α}_{{4}^{′}} {A}^{( i )}}$$

A function Q₅^{FMN} combining the different constraints explained above can also be minimized.

Thus, one obtains: Q₅^{FMN}=Q^{FMN}+αᵢCᵢ

Where αᵢ is a positive or strictly positive real number, with 1≦i≦4, i can also correspond to the index 4′, αᵢ can also correspond to the index α_{4′}.

According to one aspect of the invention, at least one tag is introduced into the scattering medium, such that the scattering medium contains p fluorescence sources, wherein the auto-fluorescence of the medium can be considered as a fluorescence source. It is attempted to locate this fluorescent tag(s) in this scattering medium.

In such a process, at least one fluorescence acquisition is therefore made by exciting the medium with a laser light source S of coordinates (i_{xS}, i_{yS}), wherein the beam of this laser source can for example be focused as a row.

The fluorescence is detected by a detector D, that can include a plurality of detectors (i_{xd}, i_{yd}) having a spectral splitting capacity, wherein these detectors can be for example aligned along an axis Xd and thus form a row of N_{xd} unit detectors.

The source and/or the plurality of detectors is moved, for example in translation, the coordinates of the source and each detector being respectively quoted (i_{xd}, i_{yd}) in a mark (X_{d}, Y_{d}) and (iₓₛ, i_{ys}) in a mark (Xₛ, Yₛ).

A configuration of measurement, or acquisition, is determined by a position of the plurality of detectors and a position of the source. At each measurement configuration, the fluorescence signal produced inside the scattering medium is measured by each detector (xd, yd) located in (ix_{d}, iy_{d}). Such signal is then separated into Nλ wavelengths, each detector (xd, yd) measuring the intensity at each wavelength iλ.

At each measurement configuration, or acquisition, the intensity of signal measured at each wavelength iλ is set out in an array X_{ixs, iys, ixd, iyd, iλ}.

The array X resulting from measurements in each configuration, then corresponding to a series of acquisitions, is then processed by factorizing into product of two non-negative matrices A and S, such that:

X_{ixs,iys,ixd,iyd,iλ}≈A_{ixs,iys,ixd,p}*S_{p,iλ}

An image of the intensity distribution of different fluorescence sources (tag or auto-fluorescence) can then be determined. As already explained above, one of the sources can be switched off and the calculation A.S which gives the distribution of other sources can be made.

Although in the examples given in the description, the objective function is based on the calculation of the Euclidian distance between the array of data X and the tensorial product A*S, other kinds of objective functions can be implemented within the scope of the invention, in particular an objective function based on the calculation of the divergence, in particular Kullback Leibler divergence. Lee and Seung have determined updating laws for this function, which ensure decreasing of the objective function in the case of a two dimension matrix X.

Therefore, we obtain

$${a}_{ixd , p} = {a}_{ixd , p} \frac{{\sum }_{i λ} \frac{{S}_{p , i λ} {X}_{ixd , i λ}}{{( AS )}_{ixd , i λ}}}{{\sum }_{i λ} {S}_{p , i λ}} et$$

$${s}_{p , i λ} = {s}_{p , i λ} \frac{{\sum }_{ixd} \frac{{A}_{ixd , p} {X}_{ixd , i λ}}{{( AS )}_{ixd , i λ}}}{{\sum }_{ixd} {A}_{ixd , p}}$$

1-17. (canceled)

18. A method for locating at least one fluorescent tag in a scattering medium including a tag, the method comprising:
a) performing at least one acquisition of fluorescence by exciting the medium, each acquisition including one or more fluorescence components due to one or plural tags, and an auto-fluorescence component due to a medium part other than the tags, data measured during the acquisition(s) being stored in a multidimensional array X, the acquisition(s) being performed by an image sensor producing an image giving spectral distribution of the fluorescence radiation;
b) processing data of the array X by factorizing the array into a product of only two known negative multidimensional arrays A and S; and
c) determining a graphical representation of the intensity distribution of one or more fluorescence components from data contained in the arrays A and S.

19. The method according to claim 18, wherein, in the processing b), A and S are determined by minimizing a cost function.

20. The method according to claim 19, wherein a cost function is, or includes, distance ∥X−AS∥² between the data of the array X and the product A·S.

21. The method according to claim 18, wherein, in the processing b), A and S are determined by an iterative process comprising, at each iteration, minimizing a cost function, the cost function comprising:
a distance between the array X and the product of the arrays A and S;
at least one distance between an array (A, S) and an initial array (A⁰, S⁰).

22. The method according to claim 18, wherein, in the processing b), at least one row of the array S is initialized by a reference spectrum of a corresponding fluorescence source.

23. The method according to claim 18, wherein, the processing b) is performed by k iterations, of arrays Aₗ₊₁ and Sₗ₊₁, obtained at an l+1-order iteration, being determined from arrays Aₗ and Sₗ obtained at a l-order iteration.

24. The method according to claim 23, wherein a number of iterations is determined depending on fluctuations in the arrays A and S, or automatically, depending on fluctuations in the cost function during two or more consecutive iterations.

25. The method according to claim 18, wherein, in the determining c), a position of one of the sources is determined by removing the contributions from other sources in the array S and then by making the product of A with the array S thus changed.

26. The method according to claim 18, wherein the excitation radiation has an infrared spectrum.

27. The method according to claim 18, wherein the fluorescence is detected at wavelengths higher than 600 nm.

28. The method according to claim 18, wherein the image is made using a detector including at least one row of unit detectors, and the row of detectors is moved, one fluorescence acquisition being performed for each position of the row of detectors.

29. The method according to claim 18, wherein the excitation is performed in an excitation area, the excitation light then scattering in a medium area different from the excitation area.

30. The method according to claim 29, wherein the excitation area is an excitation row.

31. The method according to claim 30, wherein the excitation row is moved, a fluorescence acquisition being performed for each position of the excitation row.

32. A device for locating at least one fluorescent tag in a scattering medium, comprising:
a) means for producing a fluorescent exciting beam;
b) an image sensor that performs at least one fluorescence acquisition of points of the medium, the acquisition including fluorescence components due to the different sources present in the medium, including auto-fluorescence, and therefore for producing an image giving a spectral distribution of fluorescence radiations;
c) means for processing acquisition data by factorizing into two non-negative arrays A and S;
d) means for determining a graphic representation of the intensity distribution of different fluorescence sources.

33. The device according to claim 32, further comprising means for changing a position of the excitation row.

34. The device according to claim 32, wherein at least a part of the means for performing a fluorescence acquisition of points of the medium can be disposed along a detection row, the device further including means for changing a position of the detection row.
